(19) United States
(12) Patent Application Publication
(10) Pub. No.: US 2012/0066974 A1
(43) Pub. Date: Mar. 22, 2012

(54) TAPERED DRUM PYROLYSIS

(75) Inventors: Roger Jorgenson, Swanton, OH (US); Douglas Struble, Maumee, OH (US)

(73) Assignee: RED LION BIO-ENERGY TECHNOLOGIES, Maumee, OH (US)

(21) Appl. No.: 13/237,331

(22) Filed: Sep. 20, 2011

Related U.S. Application Data
(60) Provisional application No. 61/384,578, filed on Sep. 20, 2010.

(51) Int. Cl. B01J 7/00; C01B 3/24; C10J 3/00

(52) U.S. Cl. 48/61; 422/209; 422/187; 48/197 R; 252/373

(57) ABSTRACT

Pyrolysis and gasification systems and methods are disclosed herein. In accordance with an embodiment, a feedstock hopper receives a carbonaceous feedstock that transitions into a tapered pyrolysis drum. The tapered pyrolysis drum rotates about an axis and drives off carbon based volatiles contained in the carbonaceous feedstock received from the feedstock hopper.

### PRIORITY CLAIM

This application claims the benefit of U.S. Provisional Patent Application Ser. No. 61/384,578 entitled “TAPERED DRUM PYROLYSIS” and filed Sep. 20, 2010, the entirety of which is incorporated by reference.

### TECHNICAL FIELD

The subject disclosure relates to tapered drum pyrolysis that can be utilized in the production of syngas.

### BACKGROUND

Energy production is expensive as is the removal and disposal of waste products. The world market and demand for crude oil and natural gas has grown steadily throughout the world. Political volatility in crude oil producing regions has caused a significant political risk premium to be placed on crude oil compared with other carbon based fuel sources. Attempts to exploit potential domestic oil reserves in the United States have become more difficult, both technologically and politically.

Electricity generation in developed countries is principally coal combustion based. Expansion of this segment is hampered by environmental stigma as well as increasing regulatory scrutiny. Additionally, the distribution of electric energy through the transmission grid system is under increasing stress and can be subject to catastrophic failure. In the developing world, transmission grid systems are unreliable at best, and nonexistent in many cases outside of heavily populated areas.

Bio fuel production has increased in recent years. Comestible agricultural products such as corn, soybeans, sorghum, or sugar cane can easily be converted into bio fuels to the detriment of food production. For example, since 2006, in the United States, land that was previously utilized to grow other food crops has now been converted to the cultivation of corn for bio fuels, and a large share of that corn is destined for ethanol production. Since conversion of the entire grain harvest of the United States to the production of bio fuels would only produce 16% of its automobile fuel needs, such conversion, some experts believe, could place energy markets in direct competition with food markets for scarce arable land and inevitably lead to higher food prices. Nevertheless despite the foregoing, in both agricultural production and human consumption, a tremendous amount of non-comestible biomass can be generated, causing landfill and other significant challenges.

Production of syngas from non-comestible biomass and/or other carbon based or carbonaceous materials, such as coal, peat coke, municipal solid waste, and the like, can involve the gasification and/or pyrolysis of the biomass to produce gaseous elements and/or compounds, which can be combined using steam (typically superheated steam) to produce carbon monoxide (CO), hydrogen (H₂), methane (CH₄), carbon dioxide (CO₂), and various other trace elements. The proportions of CO, H₂, CH₄, etc. can depend on various factors, such as the reactants (steam) and conditions (temperature, pressure, . . . ) employed within the gasifier, and the processing/treatment acts which the resultant gases can undergo subsequent to exiting the gasifier. Incomplete reduction of carbon compounds through incomplete pyrolysis of the incoming feedstock or biomass can produce syngas containing tars which can deleteriously diminish the quality of the syngas and can detrimentally be deposited on surfaces of the gasifier and other plant equipment leading to various processing failures.

In order to uniformly transfer heat to feedstock introduced to a pyrolysis and gasification system, prior systems have variously employed augers disposed within tubular retorts that are either fixed or rotatable. In systems where the retort is rotatable, the retort is typically rotated in a direction counter to the rotation of the auger.

In further systems, cylindrical reaction chambers disposed in series have been employed, wherein within each cylindrical reaction chamber an internal auger has been utilized. In these systems exhaust gas is directed through a reactor and around the individual cylinders so that the final cylinder in the series attains a higher temperature than the temperature of the first cylinder in the series. Each of these cylinders in series acts as a separate reaction zone with each reactor zone heated to a higher temperature than the preceding reaction zone. In addition, each cylindrical reaction chamber has been provided an auger that forces feed material on through each respective reaction chamber to the succeeding chamber. Further, the temperature of the chambers can be controlled so that the temperature of the feedstock does not rise beyond 450° F. until all the oxygen in the feed material reacts in order to prevent pyrolysis. Generally, the first reaction chamber has an initial temperature of about 100° F. with the final chamber attaining a temperature of 1000° F.

In yet further systems directed toward the transfer of heat to feedstock material for the purposes of pyrolysis and/or gasification, trans-liquefaction movement guides have been joined to temperature varied cylindrical returns, which can include endless loop conveyor systems, such as a track feeder, wherein the cylindrical motion of the returns act to physically translate the position of the movement guides.

### SUMMARY

A simplified summary is provided herein to help enable a basic or general understanding of various aspects of exemplary, non-limiting embodiments that follow in the more detailed description and the accompanying drawings. This summary is not intended, however, as an extensive or exhaustive overview. Instead, the sole purpose of this summary is to present some concepts related to some exemplary non-limiting embodiments in a simplified form as a prelude to the more detailed description of the various embodiments that.

In accordance with an embodiment this application describes a pyrolysis and gasification system that comprises a feedstock hopper that receives a carbonaceous feedstock, and a tapered pyrolysis drum that rotated about an axis and drives off carbon based volatiles contained in carbonaceous feedstock.

In accordance with a further embodiment the application describes an apparatus operable in a carbonaceous gasification environment, comprising: a hopper that supplies a carbonaceous feedstock through an airlock vessel that removes entrapped air from the carbonaceous feedstock, and a tapered pyrolysis drum that receives the carbonaceous feedstock from the airlock vessel, the tapered pyrolysis drum includes an internal flight that increases heat transfer to the carbonaceous feedstock.

In accordance with another embodiment description is made regarding a method, comprising: introducing feedstock material to a charge end of a tapered pyrolysis drum, rotating the tapered pyrolysis drum to advance the feedstock material from the charge end of the tapered pyrolysis drum to a discharge end of the tapered pyrolysis drum, heating the feedstock within the tapered pyrolysis drum, wherein a degree of heat applied at the charge end of the tapered pyrolysis drum is less than the degree of heat applied at the discharge end of the tapered pyrolysis drum, and evacuating from the discharge end of the tapered pyrolysis drum product gas, and fully pyrolyzed, or partially pyrolyzed, feedstock material.

The following description and the annexed drawings set forth in detail certain illustrative aspects of the disclosed subject matter. These aspects are indicative, however, of but a few of the various ways in which the principles of the subject application can be employed. The disclosed subject matter is intended to include all such aspects and their equivalents. Other advantages and distinctive features of the disclosed subject matter will become apparent from the following detailed description of the various embodiments when considered in conjunction with the drawings.

### BRIEF DESCRIPTION OF THE DRAWINGS

The features, nature, and advantages of the present disclosure will become more apparent from the detailed description set forth below when taken in conjunction with the drawings in which like reference characters identify correspondingly throughout and wherein:

FIG. 1 illustrates a pyrolysis and gasification system according to one embodiment.

FIG. 2 depicts the rotary aspects associated with a rotating tapered pyrolysis drum enclosed within a stationary refractory lined enclosure.

FIG. 3 provides further depiction of a rotating tapered pyrolysis drum in accordance with an embodiment.

FIG. 4 illustrates tapered pyrolysis drum disposed within a refractory lined enclosure in accordance with an embodiment.

FIG. 5 depicts a tapered pyrolysis drum with a continuously spiraling internal flight as viewed from the charge end of the tapered pyrolysis drum.

FIG. 6 depicts a cooling jacket that surrounds a conduit that connects the second counter-operating pressure valve with the accumulation chamber.

FIG. 7 illustrates a methodology for increasing heat transfer to carbonaceous feedstock introduced into a pyrolysis and gasification system via utilization of a rotating tapered pyrolysis drum with internal flights.

FIG. 8 illustrates a block diagram of a computing system operable to execute the disclosed systems and methods, in accordance with an embodiment.

### DESCRIPTION

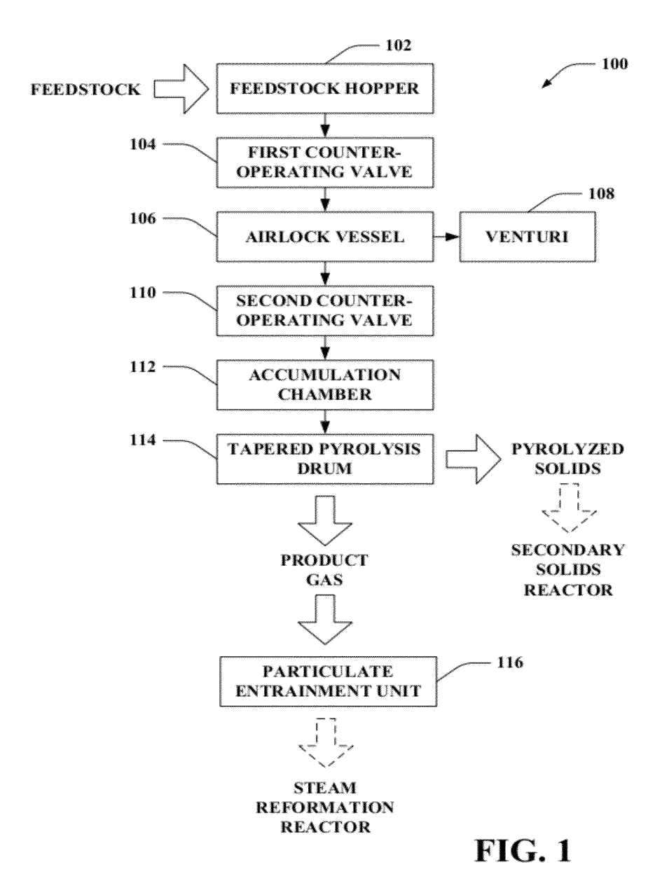

Referring to FIG. 1, a pyrolysis and gasification system 100 according to one embodiment is illustrated. Pyrolysis and gasification system 100 through use of a tapered pyrolysis drum can concentrate and increase heat transfer to feedstock introduced to the system. Pyrolysis and gasification system 100 can utilize a variety of carbon-based or carbonaceous feedstock, such as agricultural waste, industrial waste, resultant waste from human consumption, biomass recovered from cleanup of environmental disasters, forestry waste, and the like, either individually and/or in various combinations to produce synthesis gas or syngas—a gas mixture, typically comprising, hydrogen, carbon monoxide, carbon dioxide, and/or other carbon based volatile gases (e.g., methane)—that can be employed to produce combustible fuel commodities of various forms, such as hydrogen, methanol, ethanol, kerosene of various grades, and/or synthetic fuels and/or lubricating oils.

To the accomplishment of the foregoing, the depicted pyrolysis and gasification system 100 can include a feedstock hopper 102 that can accept a charge of typically non-comestible carbon-based material such as agricultural waste (e.g., corn husks, stems, leaves and/or silk, rice hulls, and/or stems, animal sewage, etc.), industrial waste (e.g., coal fines, wood chips, rubber, plastics, etc.), resultant waste from human consumption (e.g., raw or processed sewage, paper or paper products, plastics, compostable food waste, lawn and garden waste, disused tires, . . . ), biomass recovered from cleanup of environmental disasters from invasive species (e.g., wood infested by the emerald ash borer, zebra mussels in the Great Lakes, etc.), forestry waste (e.g., underbrush, invasive plant species, . . . ), and the like, and thereafter can pass the feedstock charge through a first counter-operating pressure valve 104 into an airlock vessel 106.

The first counter-operating pressure valve 104 can be a pressure valve that in combination with second counter-operating pressure valve 110 (another pressure valve) disposed subsequent to airlock vessel 106 maintains pressure within pyrolysis and gasification system 100 to a working pressure of 25-250 pounds per square inch (psi). In one embodiment, the working temperature of the pyrolysis and gasification system 100 can be about 25 psi or more and about 250 psi of less. In another embodiment, the working pressure of the pyrolysis and gasification system 100 can be about 30 psi or more and about 240 psi or less. In yet another embodiment, the working pressure of the pyrolysis and gasification system 100 can be about 50 psi or more and about 220 psi or less. In yet a further embodiment, the working pressure maintained by the pyrolysis and gasification system 100 can be about 100 psi or more and about 200 psi or less. It should be noted however, that while pyrolysis and gasification system 100 typically operates at, or maintains, working pressures of between 25-250 psi, lesser or greater working pressures than those indicated can also be beneficially utilized without departing from the intent and/or scope of the subject disclosure.

First counter-operating pressure valve 104 and second counter-operating pressure valve 110 typically operate in a manner such that when first counter-operating pressure valve 104 is opened to allow for the transition of a feedstock charge to advance from feedstock hopper 102 into airlock vessel 106, second counter-operating pressure valve 110 remains closed. Similarly, when second counter-operating pressure valve 110 is opened in order for the feedstock charge to exit from airlock vessel 106 and enter into accumulation chamber 112, the first counter-operating pressure valve remains closed. In this manner the working pressure of pyrolysis and gasification system 100 can be sustained.

As will be observed from the above, and as depicted in FIG. 1, airlock vessel 106 is generally disposed between first counter-operating pressure valve 104 and second counter-operating pressure valve 110 and is a transition vessel where any oxygen that may have been drawn in when the feedstock charge was introduced into the system through first counter-operating pressure valve 104 can be evacuated through utilization of a venturi 108. In accordance with one embodiment venturi 108 can cause a vacuum to be drawn through airlock vessel 106 on steam generated or cooling water loops, thereby evacuating any oxygen that can have been included with the feedstock charge when it passed through first counter-operating pressure valve 104 from feedstock hopper 102. Oxygen removal through utilization of a vacuum in the airlock vessel 106 decreases the amount of oxidation occurring in the system as a whole, improving desired syngas output.

Once oxygen has been extracted from airlock vessel 106 and the feedstock charge introduced in airlock vessel 106 through utilization of venturi 108, the feedstock charge transitions through second counter-operating pressure valve 110 into accumulation chamber 112.

Accumulation chamber 112 in accordance with an embodiment can be furnished with a plunger or auger that can be utilized to advance the feedstock charge into a tapered pyrolysis drum 114 where pyrolysis of the feedstock charge can be accomplished. Additionally, accumulation chamber 112 can be equipped with a port (not shown) where steam, typically heated up to 1750° F., can also be introduced. Steam introduced early on in the process allows for an earlier commencement of the reformation of pyrolysis gas into output syngas. In one embodiment, steam at about 212° F. or more can be introduced into accumulation chamber 112. In another embodiment, steam at about 1500° F. or less can be injected into accumulation chamber 112. In still yet another embodiment, steam at about 212° F. or more and about 1750° F. or less can be introduced into accumulation chamber 112. It should be noted without limitation or loss of generality, that steam heated to any temperature above or below 1750° F. can be beneficially injected into accumulation chamber 112 without departing from the intent and/or scope of the subject disclosure.

Given the proximity of second counter-operating pressure valve 110 to the tapered pyrolysis drum 114 and the fact that superheated steam is usually introduced into accumulation chamber 112, pipe(s) connecting the second counter-operating pressure valve 110 to accumulation chamber 112 can be surrounded by a cooling jacket that can be employed to dissipate heat and/or to prevent the second counter-operating pressure valve 110 from overheating and/or possibly seizing during operation. In accordance with an embodiment, the cooling jacket surrounding the pipe(s) can utilize cooled/chilled water to dissipate heat. In another embodiment, the cooling jacket surrounding the pipe(s) can employ air cooling to rapidly dissipate heat. In yet a further embodiment, the cooling jacket can use a circulating oil to effectuate cooling of the pipe(s). In still yet a further embodiment, a chilled circulating brine solution within the cooling jacket can be utilized to cool the surrounding pipe(s). Nevertheless as persons conversant in this field of endeavor will appreciate, other cooling techniques can also be utilized with equal effect and utility.

As illustrated tapered pyrolysis drum 114 can be connected to accumulation chamber 112. Since tapered pyrolysis drum 114 typically rotates (e.g., through use of an electric motor, chain, and/or sprocket combination) around one or more axes while the accumulation chamber 112 is generally stationary, accumulation chamber 112 together with its ancillary plungers or augers can be connected to the rotating tapered pyrolysis drum 114 through a mechanical seal. The mechanical seal typically allows a connection to be made between the stationary portions of pyrolysis and gasification system 100 and the rotating portions of pyrolysis and gasification system 100 while retaining system working pressure. Moreover, utilization of mechanical seals allows tapered pyrolysis drum 114 to rotate and to generate a more efficient thermal transfer to feedstock material input in the system.

In one embodiment of the subject disclosure, tapered pyrolysis drum 114 can be disposed within a refractory lined enclosure, wherein the neck of the tapered pyrolysis drum 114 can protrude from the refractory lined enclosure and rest on load bearing rollers. Further, the neck of tapered pyrolysis drum 114 can also rest on a cam follower bearing wherein the cam follower bearing is situated outside the refractory lined enclosure and positioned perpendicular to the load bearing rollers, the cam follower bearing can be utilized to restrict movement and/or direct linear growth in a single direction.

The enclosure within which tapered pyrolysis drum 114 is situated can be lined with refractory material that has thermal properties enabling temperatures of about 2400° F. to be reached within tapered pyrolysis drum 114 while the outside wall temperature of the enclosure will generally only experience a temperature of about 200° F. Typical refractory materials can include any material that is chemically and/or physically stable at high temperatures and generally can include fireclay, firebrick, or materials comprising oxides of aluminum, silicon, magnesium, or calcium.

Additionally, the enclosure within which tapered pyrolysis drum 114 is situated can include a plurality of burners which can provide graduated thermal energy to tapered pyrolysis drum 114, wherein the burners proximate to the discharge end of the tapered pyrolysis drum 114 can provide greater thermal energy than those neighboring the charge end of tapered pyrolysis drum 114. Generally, the temperature to which the plurality of burners can heat the refractory line enclosure can be anywhere between 1500-1900° F. so as to ensure that material discharged from the tapered pyrolysis drum 114 attains a temperature of at least 1450-1700° F.

In accordance with one embodiment, the refractory lined enclosure can be constructed to hold pressures of at least 50 psi, creating pressure over pressure conditions in tapered pyrolysis drum 114. Construction of a refractory lined enclosure within which tapered pyrolysis drum 114 sits and that holds a pressure of 50 psi can decrease stresses on the tapered pyrolysis drum 114 thereby increasing the life of the unit. It should be noted that under this embodiment, American Society of Mechanical Engineers (ASME) vessel codes are achievable while operating at elevated temperatures and pressures by creating low to no pressure on the tapered pyrolysis drum 114.

In accordance with a further embodiment, the refractory lined enclosure can be built to hold pressures between 15-49.9 psi, creating pressure over pressure conditions in tapered pyrolysis drum 114. Building such a refractory lined enclosure within which tapered pyrolysis drum 114 is situated decreases stresses on tapered pyrolysis drum 114 and extends the life of the drum 114. Moreover, by maintaining external pressures that are partial to the pressure of the entrained flow within the tapered pyrolysis drum 114 can bring the effective working pressure within the tapered pyrolysis drum 114 within allowable ASME working limits. Partial pressure relative to the pressure of the entrained flow within the tapered pyrolysis drum 114 can be achieved, for example, by utilizing a compressor or fan to establish pressure, or by siphoning off exhaust gas (or product of combustion) from the refractory lined enclosure and directing the exhaust gas or product of combustion to a gas turbine to create shaft horsepower necessary to pressurize the refractory lined enclosure.

In a further embodiment, the refractory line enclosure can be constructed to maintain a pressure of approximately 14.5 psi and as such can be manufactured from mild steel in which case the enclosure typically does not need to be certified as an ASME pressure vessel. In still yet a further embodiment, the refractory lined enclosure can also be open to atmospheric pressure and as such the enclosure does not generally have to be constructed to maintain pressure.

Tapered pyrolysis drum 114 in accordance with the subject disclosure typically conveys the feedstock charge from an input or charge end to an output or discharge end using internal flights. Tapered pyrolysis drum 114 is generally manufactured to ensure that no “shelf” is created when the diameter of tapered pyrolysis drum 114 narrows or constricts towards the discharge end.

Towards the discharge end, tapered pyrolysis drum 114 can comprise a neck that can rest on load bearing rollers and can subsequently be connected via a mechanical seal disposed outside the refractory line enclosure to further stationary components of pyrolysis and gasification system 100.

Once the feedstock charge has been advanced into tapered pyrolysis drum 114 through utilization of plungers or augers disposed within accumulation chamber 112, the feedstock charge can be incrementally heated so that when the pyrolyzed (or partially pyrolyzed) material attains a temperature of at least 1700° F. at the discharge end of tapered pyrolysis drum 114. The feedstock charge can be advanced through tapered pyrolysis drum 114 by use of internal flights situated within tapered pyrolysis drum 114 and the rotation of tapered pyrolysis drum 114. The rotary motion in concert with the internal flights continually folds the feedstock charge therefore allowing a constant supply of heat to be transferred to the feedstock.

It should be noted in connection with the above, the heat energy provided at the charge end of tapered pyrolysis drum 114 can be less than the heat energy expended at the discharge end of tapered pyrolysis drum 114. Thus, as the feedstock charge transitions from the charge end to the discharge end of the rotating tapered pyrolysis drum 114 it is continually being subject to ever greater amounts of heat energy provided by a plurality of burners. The heating of the feedstock charge in such a manner drives off carbon based volatiles (or product gas) such as methane, carbon monoxide, and carbon dioxide which can be directed to a steam reformation unit where further processing can be performed.

However, prior to the entrained product gas entering the steam reformation unit it can be diverted to a particulate entrapment unit where particulate of certain micron dimensions can be entrapped or prevented from entering the steam reformation unit. The entrapment of particulates of certain micro dimensions can be accomplished utilizing a venturi similar to venturi 108 associated with airlock vessel 106.

When the feedstock charge exits from the discharge end of tapered pyrolysis drum 114 it typically will have attained a temperature of at least 1700° F. but nevertheless it may not have fully given off the entirety of the carbon based volatiles contained within, thus, the discharged and pyrolyzed (possibly partially pyrolyzed) feedstock material can be directed to a secondary solids reactor where further pyrolysis of the discharged material can take place.

It should be noted in conjunction with the foregoing, that the pyrolysis characteristics of diverse feedstock material can vary, as such the size, shape, density, consistency, etc. of the feedstock charge introduced into the feedstock hopper 102 can be adaptively engineered to satisfy disparate characteristics. Thus, depending on these characteristics the feedstock charge can be of varying dimensions. Moreover, as will be comprehended by those with moderate facility in this field of endeavor, the feedstock charge introduced via feedstock hopper 102 can be pretreated or preprocessed to ensure that it comports with optimal or minimal requirements for such feedstock (e.g., reduce or increase moisture content, increase or decrease carbon content through utilization of a mix of disparate feedstock, . . . ), and further such preprocessed and/or pretreated feedstock material can be stored in environmentally controlled storage environments, such as silos.

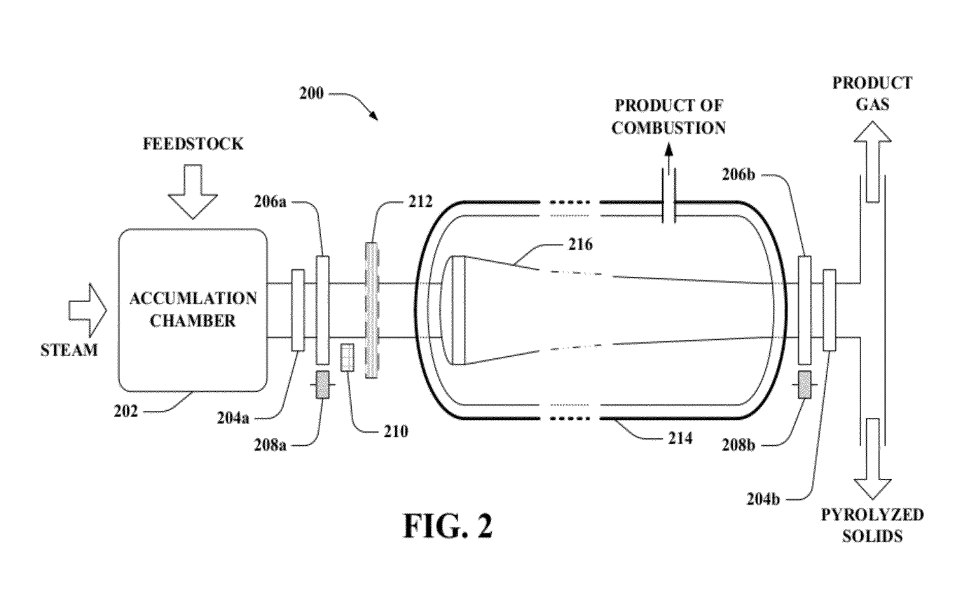

FIG. 2 provides depiction of a pyrolysis and gasification system 200, and in particular provides illustration of the rotary aspects associated with tapered pyrolysis drum 216. The rotary aspects associated with tapered pyrolysis drum 216 include roller rings 206a and 206b, load bearing rollers 208a and 208b, cam follower bearing 210, chain and/or sprocket 212, and tapered pyrolysis drum 216. In addition, mechanical seals 204a and 204b can in part have a rotary aspect as mechanical seals 204a and 204b provide transition pieces between the rotating aspects provided by roller rings 206a and 206b, load bearing rollers 208a and 208b, cam follower bearings 210, chain and/or sprocket 212, and tapered pyrolysis drum 216, and the stationary aspects of the subject disclosure (e.g., accumulation chamber 202, refractory lined enclosure 214, and conduits respectively directing product gas to a steam reformation reactor and/or pyrolyzed material discharged from tapered pyrolysis drum 216 to a secondary solids reactor for further pyrolysis).

Accumulation chamber 202 (similar to that described in connection with accumulation chamber 112) can include an auger and/or a plunger that can be utilized to advance feedstock charge into tapered pyrolysis drum 216. As stated above, accumulation chamber 202 can receive a feedstock charge depleted of oxygen from an upstream airlock vessel. Further, accumulation chamber 202 can be provided with a port (not shown) where steam heated up to 1750° F. can be introduced prior to the feedstock charge being advanced into a tapered pyrolysis drum 216. For example, feedstock and steam can contemporaneously be introduced into accumulation chamber 202, whereupon on completion of this phase, the feedstock charge suitably imbued or permeated with superheated steam can be advanced into tapered pyrolysis drum 216. Additionally and/or alternatively, or as may be periodically required in order to suitably pyrolyze feedstock within the tapered pyrolysis drum 216, steam alone or feedstock alone can be introduced into tapered pyrolysis drum 216 using the compressive properties of the auger and/or plunger to advance the steam and/or feedstock into the tapered pyrolysis drum 216.

As depicted accumulation chamber 202 can be connected through transition conduits or piping to rotating aspects of the tapered pyrolysis drum 216 via mechanical seal 204a. Mechanical seal 204a provides a transition piece between the typically stationary accumulation chamber 202 and its associated piping and/or conduits and a neck of the rotating tapered pyrolysis drum 216. Generally, the neck of the tapered pyrolysis drum 216 will be connected to the mechanical seal 204a in a manner that prevents loss of pressure within the tapered pyrolysis drum 216 but facilitates rotation of the tapered pyrolysis drum 216.

Roller ring 206a and 206b can be located proximate to mechanical seals 204a and 204b but outside refractory lined enclosure 214. Roller ring 206a can be situated at the charge neck end of the tapered pyrolysis drum 216 and roller ring 206b can be positioned to at the discharge neck end of the tapered pyrolysis drum 216. As will be understood by those ordinarily skill in the art the roller ring 206a and 206b are situated on and/or are associated with the rotating aspects of tapered pyrolysis drum 216. Thus, when tapered pyrolysis drum 216 rotates about its one or more axes, roller ring 206a and 206b, being associated with the respective protruding necks (e.g., charge neck end and discharge neck end) of the tapered pyrolysis drum 216, can rotate in concert with the rotation of tapered pyrolysis drum 216 about its axes.

In order to ensure that the respective protruding necks (e.g., charge neck end and/or discharge neck end) of tapered pyrolysis drum 216 are not left unsupported over its length and/or become subject to deformation due to the heat and/or stress of the application, roller ring 206a and 206b can rest on respective load bearing rollers 208a and 208b. Load bearing rollers 208a and 208b can be fabricated from any material conducive to the application. In one embodiment, load bearing roller 208a and/or 208b can be made of one or more metal such as aluminum, brass, bronze, steel, titanium, etc. In another embodiment load bearing rollers 208a and/or 208b can be formed of a ceramic material such as alumina, a polymeric material, such as silicone rubber, and the like. In still yet a further embodiment, one of load bearing roller 208a or 208b can be made from one or more metal while the other load bearing roller can be made of a disparate material, such as a ceramic material or polymeric material.

Additionally, to ensure that linear expansion and/or contraction of the protruding neck of the tapered pyrolysis drum 216 is appropriately restricted and/or directed in a single direction, the neck of the tapered pyrolysis drum 216 can rest on a cam follower bearing 210. Cam follower bearing 210 is usually situated outside the refractory lined enclosure 214 and proximate to roller rings (206a or 206b) and respective counterpart load bearing rollers (208a or 208b). Cam follower bearing 210 generally is positioned to be perpendicular to roller rings (206a or 206b) and respective counterpart load bearing rollers (208a or 208b). It should be noted that while only one cam follower bearing 210 is depicted positioned at the charge neck end of tapered pyrolysis drum 216, a similar cam follower bearing can be situated at the discharge neck end of tapered pyrolysis drum 216, beyond or outside the refractory lined enclosure 214, proximate to the roller rings and associated load bearing rollers, and perpendicular to roller rings and their counterpart load bearing rollers.

Like load bearing roller 208a and 208b, cam follower bearing 210 can be manufactured of any material conducive to the application. In one embodiment, cam follower bearing 210 can be made of one or more metal such as aluminum, brass, bronze, steel, titanium, etc. In another embodiment cam follower bearing 210 can be formed of a ceramic material such as alumina, a polymeric material, such as silicone rubber, and the like.

In order to rotate tapered pyrolysis drum 216 around an axis within the refractory lined enclosure 214, a sprocket 212, chain, and electric motor combination can be utilized, wherein the sprocket 212 is affixed to the charge end neck of the tapered pyrolysis drum 216 and is connected to the electric motor via a chain that meshes with the sprocket 212. Rotary motion is thereby imparted to tapered pyrolysis drum 216 by the electric motor acting through the counterpart chain and sprocket combination.

As has been stated above, tapered pyrolysis drum 216 can be placed within a refractory lined enclosure 214, wherein through the facilities of the sprocket, chain and electric motor combination tapered pyrolysis drum 216 can rotate about one or more axes. Refractory line enclosure 214 can be lined with refractory material that permits the ambient temperature within tapered pyrolysis drum 216 to be heated to a temperature of about 2400° F., while the temperature of the outside wall of the refractory lined enclosure 216 may only attain a temperature of not more than 200° F. Common refractory material that can be utilized for this application can include materials (or combinations of materials) that are chemically and physically stable at high temperatures, such as oxides of aluminum, silicon, magnesium, or calcium.

Further, refractory lined enclosure 214 can be furnished or supplied with a plurality of burners that can be positioned so that the discharge end of tapered pyrolysis drum 216 is heated to a greater extent than the charge end of tapered pyrolysis drum 216. In one embodiment, the number of burners providing thermal heating to the discharge end of tapered pyrolysis drum 216 can be greater than the number of burners providing thermal heating to the charge end of tapered pyrolysis drum 216. In a further embodiment, the burners providing thermal heating to the discharge end of tapered pyrolysis drum 216 can output greater thermal energy than the burners positioned at the charge end of tapered pyrolysis drum 216.

As will be appreciated, the plurality of burners positioned within the refractory lined enclosure 214 will typically pierce the refractory walls of the refractory lined enclosure 214, and as such accommodation needs to be made to ensure that pressure and heat energy within the refractory lined enclosure 214 is not lost due to the intrusion of the burners into the refractory lined enclosure 214.

Refractory lined enclosure 214 is typically a pressure vessel. In accordance with one embodiment, refractory lined enclosure 214 can be constructed to maintain pressures of at least 50 psi, thus creating pressure over pressure conditions within tapered pyrolysis drum 216. In a further embodiment, refractory lined enclosure 214 can be manufactured to sustain pressured of about 15 psi or more and about 49.9 psi or less, once again creating pressure over pressure conditions inside tapered pyrolysis drum 216. In still yet a further embodiment, refractory lined enclosure 214 can be fabricated to maintain pressure of approximately 14.5 psi. In still a further embodiment, refractory lined enclosure 214 can be produced so as not to maintain pressure in which case, the refractory lined enclosure 214 can be open to atmospheric pressure.

As depicted, refractory lined enclosure 214 can also be provided a port where hot exhaust gases (e.g., product of combustion) can be vented. These hot exhaust gases can be recovered and utilized as high grade waste heat and employed for steam generation and/or electrical production. Further, in some embodiments, the hot exhaust gases can be utilized to pressurize the refractory line enclosure 216 to provide pressure over pressure or pressure over partial pressure conditions within the pyrolysis and gasification system as a whole.

In regard to the foregoing, it should be noted without limitation or loss of generality, that the rotating elements illustrated in FIG. 2 are typically situated between mechanical seal 204a and 204b, but generally does not include refractory lined enclosure 214. Thus, as will be appreciated, refractory lined enclosure 214 is typically pierced by the charge end neck and/or the discharge end neck of tapered pyrolysis drum 216.

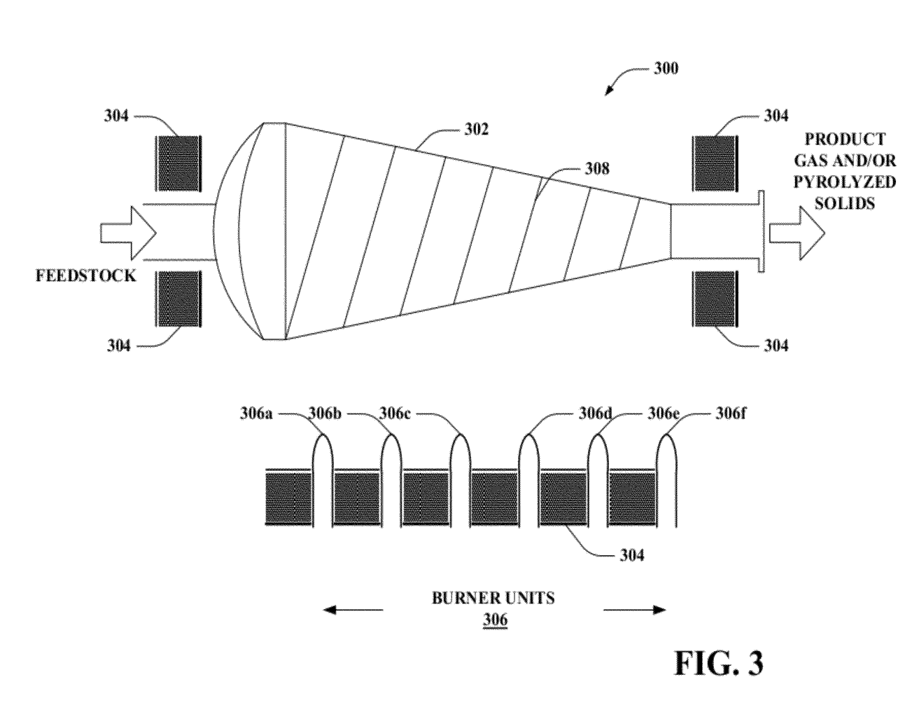

FIG. 3 provides further depiction 300 of a rotating tapered pyrolysis drum 302 in accordance with an embodiment of the subject application. As illustrated rotating tapered pyrolysis drum 302 pierces the refractory lined walls 304 of a refractory lined enclosure. Further, as depicted rotating tapered pyrolysis drum 302 can include internal flights 308 that, in conjunction with the rotary motion of rotating tapered pyrolysis drum 302, steadily progress feedstock introduced at the charge end of rotating tapered pyrolysis drum 302 (e.g., through a charge neck end) to gradually transition through rotating tapered pyrolysis drum 302 and exit from the discharge end of the rotating tapered pyrolysis drum 302 (e.g., through a discharge neck end), whereupon the discharged feedstock material (e.g., completely pyrolyzed and/or partially pyrolyzed) can, if necessary, be directed to a second solids reactor for further pyrolysis. Typically, internal flights 308 can be helically disposed on interior surfaces of rotating tapered pyrolysis drum 302 to ensure that the feedstock material transitioning through rotating tapered pyrolysis drum 302 is folded so as to ensure constant and even heat transfer to the transitioning feedstock material.

As described earlier, a plurality of burners 306 can be positioned within and can penetrate through the refractory lined walls 304 of the refractory lined enclosure. In one embodiment, there can be a greater number of burners 306 situated toward the discharge end (e.g., where product gas and/or fully or partially pyrolyzed solids exits) of tapered pyrolysis drum 302 to provide greater heating capacity toward the discharge end. Additionally and/or alternatively, the burners 306 disposed at the discharge end of tapered pyrolysis drum 302 can have a greater thermal capacity than burners 306 situated at the charge end of pyrolysis drum 302. Further, burners 306 can be located within the refractory lined enclosure 304 such that the burners are successively positioned from the charge end to the discharge end of tapered pyrolysis drum 302 have successively greater thermal output capacity. In another embodiment, there can be a lesser number of burners 306 positioned at the discharge end of tapered pyrolysis drum 302 but a greater number of burners 306 at the charge end of tapered pyrolysis drum 302. Additionally and/or alternatively, burners 306 (or individual burners) located proximal to the charge end of tapered pyrolysis drum 302 can have greater thermal capacity than burners 306 (or individual burners) positioned at the discharge end of tapered pyrolysis drum 302.

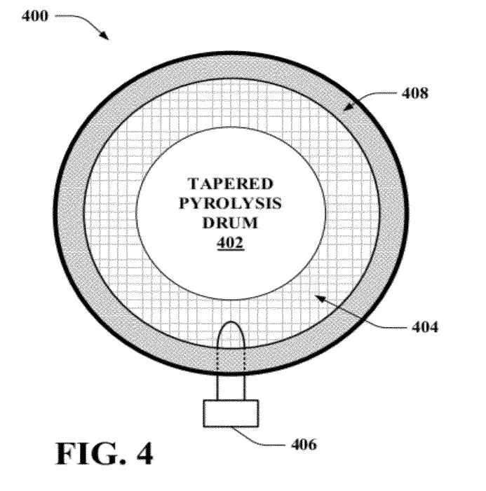

FIG. 4 illustrates tapered pyrolysis drum 402 disposed within a refractory lined enclosure. As depicted tapered pyrolysis drum 402 during operation of the gasification and pyrolysis system can be surrounded by hot gas or product of combustion 404. In one embodiment, the hot gas or product of combustion 404 can be subject to a pressure of about 50 psi thereby creating a pressure over pressure situation within tapered pyrolysis drum 402. Creating and maintaining a pressure over pressure situation in the tapered pyrolysis drum 402 can decrease stresses on the tapered pyrolysis drum 402 and increase the useful working life of the unit.

In another embodiment, the hot gas or product of combustion 404 can be subject to a pressure of about 15 psi or more and about 49.9 psi or less, creating a partial pressure over pressure situation within tapered pyrolysis drum 402. Creating and/or maintaining a partial pressure over pressure situation inside the tapered pyrolysis drum 402 decreases stress on the tapered pyrolysis drum 402 and in turn increases the working life of the unit. As noted above, partial pressure conditions within the refractory lined enclosure (and partial pressure over pressure conditions within tapered pyrolysis drum 402) can be created and/or maintained by using a compressor fan to build and/or sustain pressure, and/or partial pressure can be built and/or maintained by utilizing the continuously vented surplus/overpressure exhaust gas (e.g., product of combustion vented through a port on refractory lined enclosure 214) and feeding this gas back into the refractory lined enclosure.

In some embodiments, the hot gas or product of combustion 404 can be subject to a pressure of less than 14.5 psi or can open to atmospheric pressure, in which case the refractory lined enclosure need only be fabricated out of mild steel and/or does not need to be manufactured to hold pressure.

The plurality of burners 406 in accordance with one embodiment can be located so that they penetrate the walls 408 along the bottom of the refractory lined enclosure. In another embodiment, the plurality of burners 406 can be arranged so that they penetrate the walls 408 along the top of the refractory lined enclosure. In accordance with a further embodiment, the plurality of burners 406 can be positioned so that burners 406 penetrate the walls 408 along the transverse length of the refractory lined enclosure (e.g., from the charge end of tapered pyrolysis drum to the discharge end of tapered pyrolysis drum) and are arranged equidistantly around a center point (e.g., tapered pyrolysis drum 402).

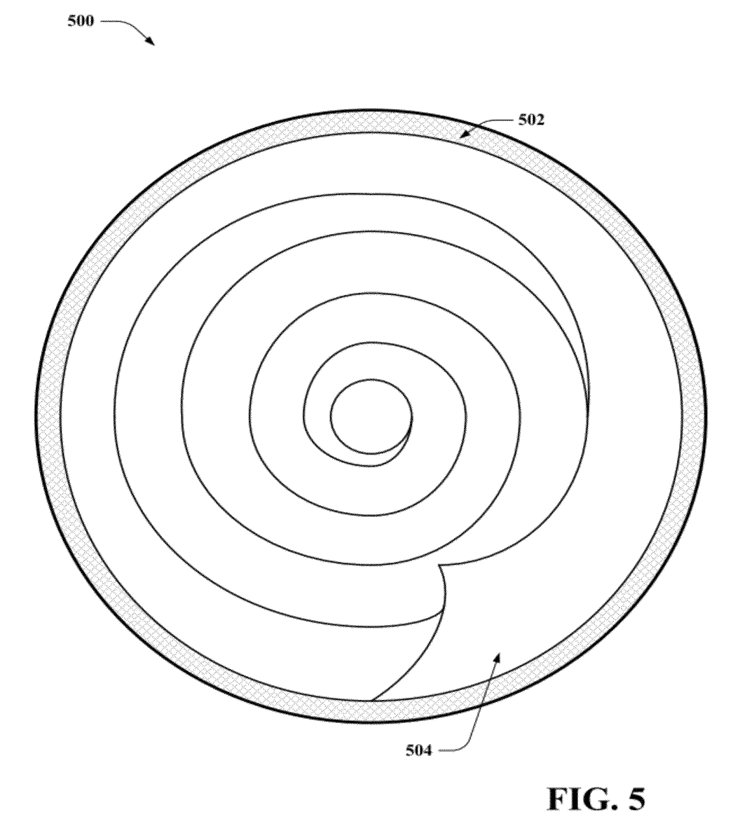

FIG. 5 depicts tapered pyrolysis drum 502 with a continuously spiraling internal flight 504 as viewed from the charge end of tapered pyrolysis drum 502. Spiraling internal flight 504 flight can commence the charge end of tapered pyrolysis drum 502 and terminate at the discharge end of tapered pyrolysis drum 502. Spiraling internal flight 504 can gradually advance feedstock input at the charge end of tapered pyrolysis drum 502 to the discharge end of tapered pyrolysis drum 502 while tapered pyrolysis drum 502 rotates about an axis.

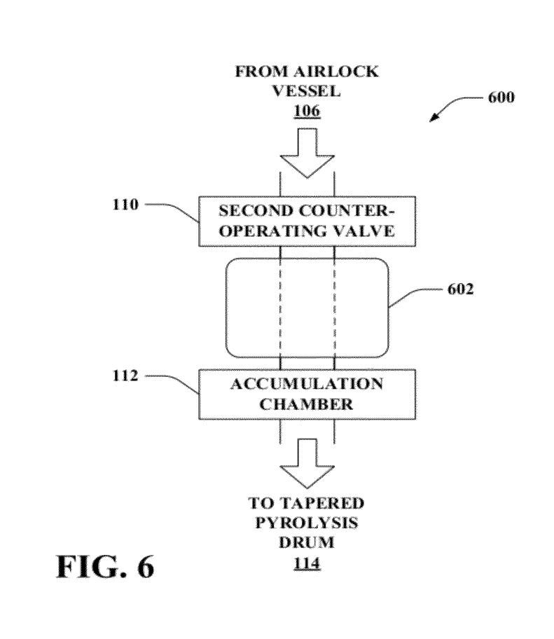

FIG. 6 depicts 600 a cooling jacket 602 that surrounds a pipe(s) that connects second counter-operating pressure valve 110 and accumulation chamber 112. As stated earlier, given the proximity of the second counter-operating pressure valve 110 to the accumulation chamber 112 and tapered pyrolysis drum 114, the fact that steam or superheated steam is introduced into accumulation chamber 112 to begin transforming pyrolysis gas into syngas, and the heat that can be radiated from the refractory lined enclosure within which tapered pyrolysis drum 112 can be situated, the pipe(s) connecting the second counter-operating pressure valve 110 can be surrounded by a cooling jacket 602 utilized to dissipate heat and/or to prevent the second counter-operating pressure valve 110 from overheating and/or seizing during operation. In accordance with an embodiment, cooling jacket 602 can effectuate air cooling, wherein a plurality of fins are formed on the pipe(s) connecting the second counter-operating pressure valve 110 to the accumulation chamber 112. In a further embodiment, cooling jacket 602 can effectuate dissipation of heat by circulating oil through conduits embedded within the jacket. In yet a further embodiment, cooling jacket 602 can cool the pipe(s) descending from second counter-operating pressure valve 110 using a chilled brine solution circulating through enclosed channels formed within the jacket.

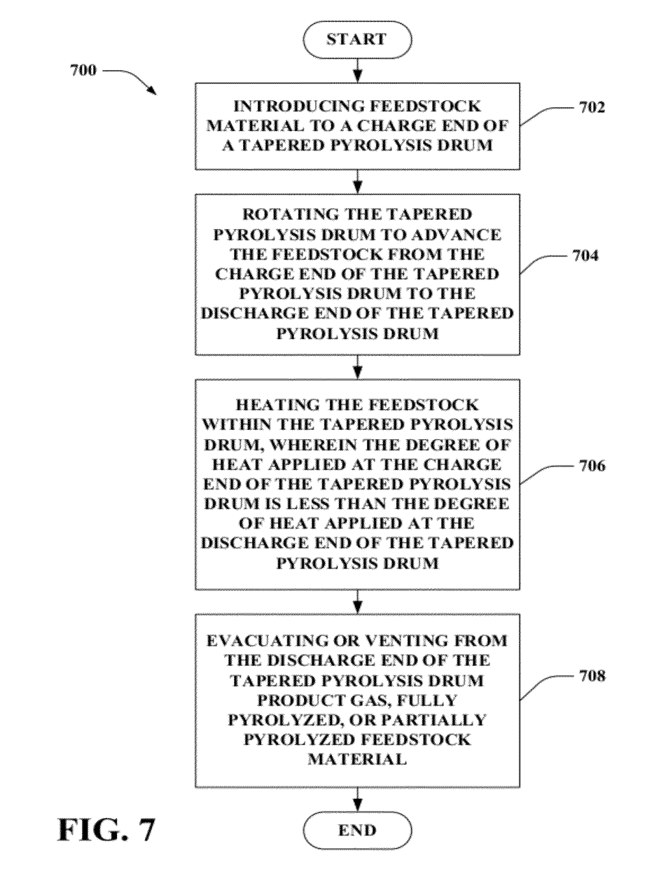

FIG. 7 illustrates a method 700 for increasing heat transfer to feedstock introduced to a pyrolysis and gasification system via utilization of a tapered drum. At 702 feedstock material infused with steam (or superheated steam) can be introduced to a charge end of a tapered pyrolysis drum that rotates within a refractory lined enclosure. At 704 the tapered pyrolysis drum can be rotated to gradually advance the feedstock material from the charge end to the discharge end of the tapered pyrolysis drum. The feedstock material is steadily advanced and/or continuously folded through use of flights positioned within the tapered pyrolysis drum and the rotation of the tapered pyrolysis drum.

At 706 the feedstock material within the rotating tapered pyrolysis drum is gradually heated, wherein the degree of thermal energy applied at the charge end of the rotating tapered pyrolysis drum is less than the degree of thermal energy expended at the discharge end of the rotating tapered pyrolysis drum. At 708, due to the rotation of the tapered pyrolysis drum and the internal flights positioned within the tapered pyrolysis drum, fully pyrolyzed (or partially pyrolyzed) feedstock material is evacuated from the discharge end of the tapered pyrolysis drum. On exiting from the discharge end of the tapered pyrolysis drum the feedstock material will typically have attained a temperature of at least 1700° F., but nonetheless might not have fully given off the entirety of carbon based volatiles contained therein, thus, the discharged feedstock material can be directed to a secondary solids reactor where further pyrolysis of the material can take place so that further carbon based volatiles can be driven off the material. Additionally at 708, carbon based volatiles (or product gas) driven off the feedstock material during its gradual transition through the tapered pyrolysis drum can be directed to a steam reformation unit where further processing and/or transformation of the product gas into syngas can be performed. Nevertheless, as has been noted above, prior to directing the entrained product gas to the steam reformation unit the entrained gas can be diverted to a particulate entrapment unit where particulate matter of specified or specific dimensions can be entrapped or prevented from entering the steam reformation unit.

As used herein, the term to “infer” or “inference” refers generally to the process of reasoning about or inferring states of the system, environment, and/or user from a set of observations as captured via events and/or data. Inference can be employed to identify a specific context or action, or can generate a probability distribution over states, for example. The inference can be probabilistic—that is, the computation of a probability distribution over states of interest based on a consideration of data and events. Inference can also refer to techniques employed for composing higher-level events from a set of events and/or data. Such inference results in the construction of new events or actions from a set of observed events and/or stored event data, whether or not the events are correlated in close temporal proximity, and whether the events and data come from one or several event and data sources.

It is understood that the specific order or hierarchy of steps in the processes disclosed is an example of exemplary approaches. Based upon design preferences, it is understood that the specific order or hierarchy of steps in the processes may be rearranged while remaining within the scope of the present disclosure. The accompanying method claims present elements of the various steps in a sample order, and are not meant to be limited to the specific order or hierarchy presented.

Those of skill in the art would understand that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

Those of skill would further appreciate that the various illustrative logical blocks, modules, circuits, and algorithm steps described in connection with the embodiments disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

The various illustrative logical blocks, modules, and circuits described in connection with the embodiments disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

The steps of a method or algorithm described in connection with the embodiments disclosed herein may be embodied directly in hardware, in a software module executed by a processor, or in a combination of the two. A software module may reside in RAM memory, flash memory, ROM memory, EPROM memory, EEPROM memory, registers, hard disk, a removable disk, a CD-ROM, or any other form of storage medium known in the art. An exemplary storage medium is coupled to the processor such the processor can read information from, and write information to, the storage medium. In the alternative, the storage medium may be integral to the processor. The processor and the storage medium may reside in an ASIC. The ASIC may reside in a user terminal. In the alternative, the processor and the storage medium may reside as discrete components in a user terminal.

With respect to any figure or numerical range for a given characteristic, a figure or a parameter from one range may be combined with another figure or a parameter from a different range for the same characteristic to generate a numerical range.

Other than in the operating examples, or where otherwise indicated, all numbers, values and/or expressions referring to quantities of ingredients, reaction conditions, etc., used in the specification and claims are to be understood as modified in all instances by the term “about.”

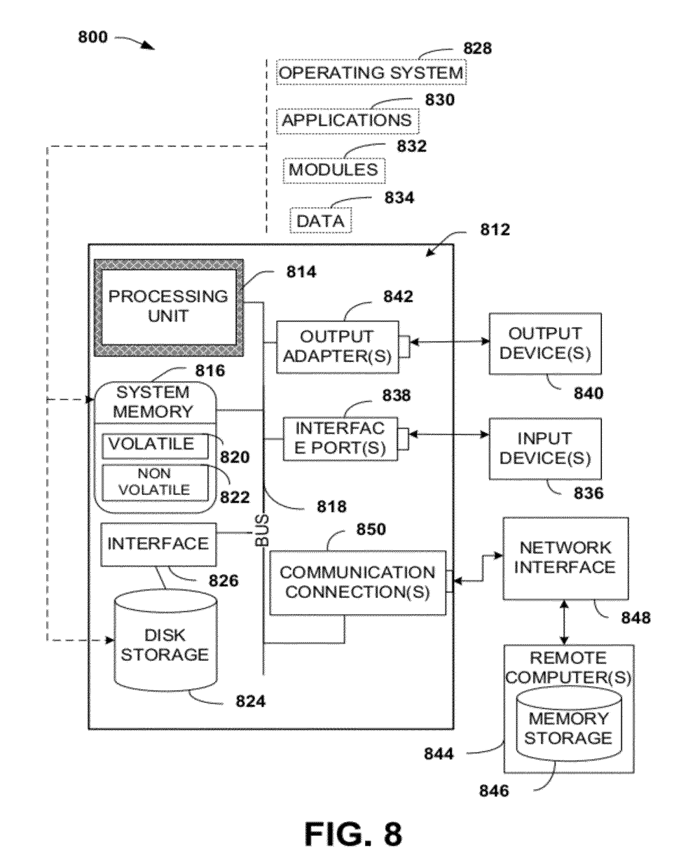

In order to provide a context for the various aspects of the disclosed subject matter, FIG. 8, and the following discussion, are intended to provide a brief, general description of a suitable environment in which the various aspects of the disclosed subject matter can be implemented, e.g., various processes associated with FIGS. 1-7. While the subject matter has been described above in the general context of computer-executable instructions of a computer program that runs on a computer and/or computers, those skilled in the art will recognize that the subject application also can be implemented in combination with other program modules. Generally, program modules include routines, programs, components, data structures, etc. that perform particular tasks and/or implement particular abstract data types.

Moreover, those skilled in the art will appreciate that the inventive systems can be practiced with other computer system configurations, including single-processor or multiprocessor computer systems, mini-computing devices, mainframe computers, as well as personal computers, hand-held computing devices (e.g., PDA, phone, watch), microprocessor-based or programmable consumer or industrial electronics, and the like. The illustrated aspects can also be practiced in distributed computing environments where tasks are performed by remote processing devices that are linked through a communications network; however, some if not all aspects of the subject disclosure can be practiced on stand-alone computers. In a distributed computing environment, program modules can be located in both local and remote memory storage devices.

With reference to FIG. 8, a block diagram of a computing system 800 operable to execute the disclosed systems and methods is illustrated, in accordance with an embodiment. Computer 812 includes a processing unit 814, a system memory 816, and a system bus 818. System bus 818 couples system components including, but not limited to, system memory 816 to processing unit 814. Processing unit 814 can be any of various available processors. Dual microprocessors and other multiprocessor architectures also can be employed as processing unit 814.

System bus 818 can be any of several types of bus structure(s) including a memory bus or a memory controller, a peripheral bus or an external bus, and/or a local bus using any variety of available bus architectures including, but not limited to, Industrial Standard Architecture (ISA), Micro-Channel Architecture (MSA), Extended ISA (EISA), Intelligent Drive Electronics (IDE), VESA Local Bus (VLB), Peripheral Component Interconnect (PCI), Card Bus, Universal Serial Bus (USB), Advanced Graphics Port (AGP), Personal Computer Memory Card International Association bus (PCMCIA), Firewire (IEEE 1194), and Small Computer Systems Interface (SCSI).

System memory 816 includes volatile memory 820 and nonvolatile memory 822. A basic input/output system (BIOS), containing routines to transfer information between elements within computer 812, such as during start-up, can be stored in nonvolatile memory 822. By way of illustration, and not limitation, nonvolatile memory 822 can include ROM, PROM, EPROM, EEPROM, or flash memory. Volatile memory 820 includes RAM, which acts as external cache memory. By way of illustration and not limitation, RAM is available in many forms such as SRAM, dynamic RAM (DRAM), synchronous DRAM (SDRAM), double data rate SDRAM (DDR SDRAM), enhanced SDRAM (ESDRAM), Synchlink DRAM (SLDRAM), Rambus direct RAM (RDRAM), direct Rambus dynamic RAM (DRDRAM), and Rambus dynamic RAM (RDRAM).

Computer 812 can also include removable/non-removable, volatile/non-volatile computer storage media, networked attached storage (NAS), e.g., SAN storage, etc. FIG. 8 illustrates, for example, disk storage 824. Disk storage 824 includes, but is not limited to, devices like a magnetic disk drive, floppy disk drive, tape drive, Jaz drive, Zip drive, LS-100 drive, flash memory card, or memory stick. In addition, disk storage 824 can include storage media separately or in combination with other storage media including, but not limited to, an optical disk drive such as a compact disk ROM device (CD-ROM), CD recordable drive (CD-R Drive), CD rewritable drive (CD-RW Drive) or a digital versatile disk ROM drive (DVD-ROM). To facilitate connection of the disk storage devices 824 to system bus 818, a removable or non-removable interface is typically used, such as interface 826.

It is to be appreciated that FIG. 8 describes software that acts as an intermediary between users and computer resources described in suitable operating environment 800. Such software includes an operating system 828. Operating system 828, which can be stored on disk storage 824, acts to control and allocate resources of computer 812. System applications 830 take advantage of the management of resources by operating system 828 through program modules 832 and program data 834 stored either in system memory 816 or on disk storage 824. It is to be appreciated that the disclosed subject matter can be implemented with various operating systems or combinations of operating systems.

A user can enter commands or information into computer 812 through input device(s) 836. Input devices 836 include, but are not limited to, a pointing device such as a mouse, trackball, stylus, touch pad, keyboard, microphone, joystick, game pad, satellite dish, scanner, TV tuner card, digital camera, digital video camera, web camera, and the like. These and other input devices connect to processing unit 814 through system bus 818 via interface port(s) 838. Interface port(s) 838 include, for example, a serial port, a parallel port, a game port, and a universal serial bus (USB). Output device(s) 840 use some of the same type of ports as input device(s) 836.

Thus, for example, a USB port can be used to provide input to computer 812 and to output information from computer 812 to an output device 840. Output adapter 842 is provided to illustrate that there are some output devices 840 like monitors, speakers, and printers, among other output devices 840, which use special adapters. Output adapters 842 include, by way of illustration and not limitation, video and sound cards that provide means of connection between output device 840 and system bus 818. It should be noted that other devices and/or systems of devices provide both input and output capabilities such as remote computer(s) 844.

Computer 812 can operate in a networked environment using logical connections to one or more remote computers, such as remote computer(s) 844. Remote computer(s) 844 can be a personal computer, a server, a router, a network PC, a workstation, a microprocessor based appliance, a peer device, or other common network node and the like, and typically includes many or all of the elements described relative to computer 812.

For purposes of brevity, only a memory storage device 846 is illustrated with remote computer(s) 844. Remote computer(s) 844 is logically connected to computer 812 through a network interface 848 and then physically connected via communication connection 850. Network interface 848 encompasses wire and/or wireless communication networks such as local-area networks (LAN) and wide-area networks (WAN). LAN technologies include Fiber Distributed Data Interface (FDDI), Copper Distributed Data Interface (CDDI), Ethernet, Token Ring and the like. WAN technologies include, but are not limited to, point-to-point links, circuit switching networks like Integrated Services Digital Networks (ISDN) and variations thereon, packet switching networks, and Digital Subscriber Lines (DSL).

Communication connection(s) 850 refer(s) to hardware/software employed to connect network interface 848 to bus 818. While communication connection 850 is shown for illustrative clarity inside computer 812, it can also be external to computer 812. The hardware/software for connection to network interface 848 can include, for example, internal and external technologies such as modems, including regular telephone grade modems, cable modems and DSL modems, ISDN adapters, and Ethernet cards.

The above description of illustrated embodiments of the subject disclosure, including what is described in the Abstract, is not intended to be exhaustive or to limit the disclosed embodiments to the precise forms disclosed. While specific embodiments and examples are described herein for illustrative purposes, various modifications are possible that are considered within the scope of such embodiments and examples, as those skilled in the relevant art can recognize.

In this regard, while the disclosed subject matter has been described in connection with various embodiments and corresponding Figures, where applicable, it is to be understood that other similar embodiments can be used or modifications and additions can be made to the described embodiments for performing the same, similar, alternative, or substitute function of the disclosed subject matter without deviating therefrom. Therefore, the disclosed subject matter should not be limited to any single embodiment described herein, but rather should be construed in breadth and scope in accordance with the appended claims below.

The previous description of the disclosed embodiments is provided to enable any person skilled in the art to make or use the present disclosure. Various modifications to these embodiments will be readily apparent to those skilled in the art, and the generic principles defined herein may be applied to other embodiments without departing from the spirit or scope of the disclosure. Thus, the present disclosure is not intended to be limited to the embodiments shown herein but is to be accorded the widest scope consistent with the principles and novel features disclosed herein.

What is claimed is:

1. A pyrolysis and gasification system, comprising:
a feedstock hopper that receives a carbonaceous feedstock; and
a tapered pyrolysis drum that rotates about an axis and drives off carbon based volatiles contained in the carbonaceous feedstock.

2. The system of claim 1, the pyrolysis and gasification system increases heat transfer to the carbonaceous feedstock through use of internal flights within the tapered pyrolysis drum.

3. The system of claim 1, further comprising a first counter-operating pressure valve and a second counter-operating pressure valve.

4. The system of claim 3, the first counter-operating pressure valve and the second counter-operating pressure valve maintain a pressure of at least 50 pounds per square inch (psi) within the pyrolysis and gasification system.

5. The system of claim 3, the first counter-operating pressure valve and the second counter-operating pressure valve maintain a pressure of at least 250 pounds per square inch (psi) within the pyrolysis and gasification system.

6. The system of claim 3, further comprising an airlock vessel disposed between the first counter-operating pressure valve and the second counter-operating pressure valve.

7. The system of claim 6, the airlock vessel holds a charge of feedstock received from the feedstock hopper.

8. The system of claim 6, the airlock vessel draws in a vacuum that evacuates oxygen introduced into the airlock vessel when feedstock is introduced into the airlock vessel.

9. The system of claim 8, the vacuum is drawn through a venturi on steam generated or cooling water loops.

10. The system of claim 3, further comprising an accumulation chamber located after the second counter-operating pressure valve.

11. The system of claim 10, the accumulation chamber includes a plunger/auger that advances a charge of feedstock into the tapered pyrolysis drum.

12. The system of claim 3, further comprises a cooling jacket that surrounds a pipe connecting the second counter-operating pressure valve and an accumulation chamber.

13. The system of claim 12, the cooling jacket utilizes cooling water passed through the cooling jacket to dissipate heat or prevent the second counter-operating pressure valve from overheating.

14. The system of claim 1, the tapered pyrolysis drum is connected to an accumulation chamber via a mechanical seal.

15. The system of claim 14, superheated steam is introduced into the accumulation chamber via a port in the accumulation chamber.

16. The system of claim 15, the superheated steam is heated to at least 1750° F.

17. The system of claim 1, the tapered pyrolysis drum includes a neck that protrudes beyond a refractory lined enclosure.

18. The system of claim 17, the neck rests on a load bearing roller.

19. The system of claim 18, a cam follower bearing is located outside the refractory lined enclosure and is disposed perpendicular to the load bearing roller.

20. The system of claim 19, the cam follower bearing restricts movement or direct linear growth of the tapered pyrolysis drum in one direction.

21. The system of claim 17, the tapered pyrolysis drum enclosed within the refractory line enclosure.

22. The system of claim 17, the refractory lined enclosure includes at least one burner that provides thermal energy to the pyrolysis and gasification system.

23. The system of claim 17, the refractory lined enclosure constructed to sustain a pressure of at least 50 psi, creating a pressure over pressure environment within the tapered pyrolysis drum.

24. The system of claim 17, the refractory lined enclosure fabricated to maintain pressured of at least 15 psi or less than 49.9 psi, creating a partial pressure over pressure environment within the tapered pyrolysis drum.

25. The system of claim 24, the partial pressure over pressure environment within the tapered pyrolysis drum established by a compressor or a fan employed to build up pressure.

26. The system of claim 24, the partial pressure over pressure environment within the tapered pyrolysis drum established by siphoning off exhaust gas from the refractory lined enclosure and directing the exhaust gas to a gas turbine to create shaft horsepower.

27. The system of claim 26, the shaft horsepower utilized to spin a device that compresses ambient air or combustion air, wherein the compressed ambient air or combustion air is fed back to the refractory lined enclosure to build up or sustain the partial pressure over pressure environment established in the tapered pyrolysis drum.

28. The system of claim 17, the refractory lined enclosure constructed to maintain a pressure of at least 14.5 psi, wherein the refractory lined enclosure is constructed of mild steel.

29. The system of claim 17, the refractory lined enclosure is manufactured to operate at atmospheric pressure.

30. The system of claim 17, heat vented from the refractory line enclosure is employed for steam generation or power production.

31. The system of claim 1, a mechanical seal is utilized between the tapered pyrolysis drum and stationary portions of the pyrolysis and gasification system.

32. The system of claim 31, the mechanical seal operates to maintain a working pressure within the tapered pyrolysis drum.

33. The system of claim 1, the tapered pyrolysis drum rotated about an axis by an electric motor connected to a chain and sprocket.

34. The system of claim 1, the tapered pyrolysis drum conveys carbonaceous feedstock from an input end to a discharge end of the tapered pyrolysis drum via internal flights.

35. The system of claim 1, the tapered pyrolysis drum is constructed to ensure that no shelf is created when a diameter of the tapered pyrolysis drum constricts back to an exit gas pipe size.

36. The system of claim 1, fully pyrolyzed or partially pyrolyzed carbonaceous feedstock exits from a discharge end of the tapered pyrolysis drum at a temperature of more than 1450° F. and less than 1700° F.

37. The system of claim 36, the discharge end includes a neck that rests on a load bearing roller, the neck is connected to a stationary piece of the gasification and pyrolysis system through a mechanical seal located external to a refractory lined vessel, the neck rotatable around an axis on the load bearing roller.

38. The system of claim 37, product gas exits from the tapered pyrolysis drum into a steam reformer.

39. The system of claim 37, partially pyrolyzed carbonaceous feedstock transitions via an auger to a secondary solids reactor, the secondary solids reactor employed to complete conversion of the partially pyrolyzed carbonaceous feedstock into syngas.

40. The system of claim 39, further comprising a selective particulate entrapment component that employs a venturi placed between the tapered pyrolysis drum and a secondary solids reactor, wherein the venturi captures particles below a specified micro size in an entrained flow of gas and steam entering a reforming reactor.

41. An apparatus operable in a carbonaceous gasification environment, comprising:
a hopper that supplies a carbonaceous feedstock through an airlock vessel that removes entrapped air from the carbonaceous feedstock; and
a tapered pyrolysis drum that receives the carbonaceous feedstock from the airlock vessel, the tapered pyrolysis drum includes an internal flight that increases heat transfer to the carbonaceous feedstock.

42. A method, comprising:
introducing feedstock material to a charge end of a tapered pyrolysis drum;
rotating the tapered pyrolysis drum to advance the feedstock material from the charge end of the tapered pyrolysis drum to a discharge end of the tapered pyrolysis drum;
heating the feedstock within the tapered pyrolysis drum, wherein a degree of heat applied at the charge end of the tapered pyrolysis drum is less than the degree of heat applied at the discharge end of the tapered pyrolysis drum; and
evacuating from the discharge end of the tapered pyrolysis drum product gas, and fully pyrolyzed, or partially pyrolyzed, feedstock material.
